(19) United States
(12) Patent Application Publication
(10) Pub. No.: US 2015/0264855 A1
(43) Pub. Date: Sep. 24, 2015

(54) Garden Tool for Weed Removal

(71) Applicant: Ray Lukensow, North Richland Hills, TX (US)

(72) Inventor: Ray Lukensow, North Richland Hills, TX (US)

(21) Appl. No.: 14/661,254

(22) Filed: Mar. 18, 2015

Related U.S. Application Data
(60) Provisional application No. 61/954,640, filed on Mar. 18, 2014.

(51) Int. Cl. A01B 1/16

(52) U.S. Cl. CPC A01B 1/16

(57) ABSTRACT

A garden tool particularly suited for use in removing weeds. The garden tool includes an elongated shaft having a handle at a first end thereof and a tool head at a second end thereof. The handle is arranged at an angle relative to a vertical plane and is angled in a forward direction so as to allow the user to obtain better leverage when driving the tool head into the ground. The tool head includes a ledge having a rounded upper surface and one or more tines extending from the lower surface of the ledge. The tines preferably are preferably arcuate in configuration and include a slight curvature in a forward direction. The tines comprise a pointed end adapted to facilitate penetration of the ground. In operation, the user can apply pressure on the ledge of the tool head in order to drive the tines into the ground.

### CROSS REFERENCE TO RELATED APPLICATION

This application claims the benefit of U.S. Provisional Application No. 61/954,640 filed on Mar. 18, 2014. The above identified patent application is herein incorporated by reference in its entirety to provide continuity of disclosure.

### BACKGROUND OF THE INVENTION

### Field of the Invention

The present invention relates to garden tools. More specifically, the present invention provides a garden tool adapted for use in removing weeds and weed roots. The garden tool comprises an elongated shaft having a handle at a first end thereof and a tool head at a second end thereof, wherein the handle is disposed at an angle relative to a vertical plane. The tool head comprises a ledge on which pressure can be applied to drive the tool head into the ground, and one or more arcuate tines extending from the ledge that are adapted to penetrate the ground.

Lawns and gardens must be carefully maintained in order to eliminate weeds and to inhibit the growth of weeds. Weeds can be difficult to remove by hand because many weeds have roots that extend deep into the soil. As a result, people are typically unable to fully remove the weed and its roots by hand. The user may remove only part of the weed, allowing the roots to remain in place. This is problematic as the weed is not fully removed and may continue to sprout or develop.

Conventional garden tools may be used to try to more easily remove weeds and their roots from the ground. However, such garden tools can be difficult to use and are not well suited to removing weeds with deep roots. People may have difficulty applying sufficient force to the garden tool to penetrate the surface of the ground in order to position the garden tool underneath the weed. Further, garden tools do not include a tool head having the correct shape that allows the tool head to extend underneath the weed. Thus, a garden tool that allows a person to more easily remove weeds and their roots is desired.

Devices have been disclosed in the prior art that relate to garden tools. These include devices that have been patented and published in patent application publications. These devices generally relate to garden tool and weed removal tools. U.S. Pat. No. 5,005,888, U.S. Pat. No. 5,257,666, and U.S. Pat. No. 1,134,618 provide garden tools for extracting plants having one or more prongs thereon. U.S. Published Patent Application Number 2014/0027136, U.S. Pat. No. 5,207,466, and U.S. Pat. No. 1,092,818 disclose weed removing devices having prongs arranged in a circular pattern.

These prior art devices have several known drawbacks. The garden tools in the prior art fail to disclose a garden tool having a ledge on the tool head on which a user can position his or her foot in order to drive the tool head into the ground. Further, the devices in the prior art failed to provide an elongated shaft disposed at an angle relative to a vertical plane to allow the user to have greater leverage when driving the tines of the tool head into the ground. Thus, the tools do not allow a user to easily insert the prongs or tines of the garden tool beneath a weed and the roots thereof in order to remove the same.

In light of the devices disclosed in the prior art, it is submitted that the present invention substantially diverges in design elements from the prior art and consequently it is clear that there is a need in the art for an improvement to existing garden tool devices. In this regard the instant invention substantially fulfills these needs.

### SUMMARY OF THE INVENTION

In view of the foregoing disadvantages inherent in the known types of garden tools now present in the prior art, the present invention provides a new garden tool wherein the same can be utilized for providing convenience for the user when completely removing weeds and their roots from a lawn or garden.

It is therefore an object of the present invention to provide a new and improved garden tool device that has all of the advantages of the prior art and none of the disadvantages.

It is another object of the present invention to provide a garden tool device comprising an elongated shaft with a first end and a second end, wherein the first end includes a handle and a second end includes a tool head with a ledge and tines thereon.

Another object of the present invention is to provide a garden tool device comprising a tool head having one or more arcuate tines extending therefrom.

Yet another object of the present invention is to provide a garden tool having an elongated shaft disposed at an angle relative to a vertical plane adapted to allow a user to obtain better leverage when inserting the tines of the tool head into the ground.

A further object of the present invention is to provide a garden tool having one or more arcuate tines having pointed ends.

Another object of the present invention is to provide a garden tool that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the garden tool of the present invention.

FIG. 2 shows a side view of the garden tool of the present invention.

FIG. 3 shows a front view of the garden tool of the present invention.

FIG. 4 shows a view of the garden tool of the present invention in use.

### DETAILED DESCRIPTION OF THE INVENTION

Reference is made herein to the attached drawings. Like reference numerals are used throughout the drawings to depict like or similar elements of the garden tool. For the purposes of presenting a brief and clear description of the present invention, the preferred embodiment will be discussed as used for facilitating the removal of weeds and the roots thereof. The figures are intended for representative purposes only and should not be considered to be limiting in any respect.

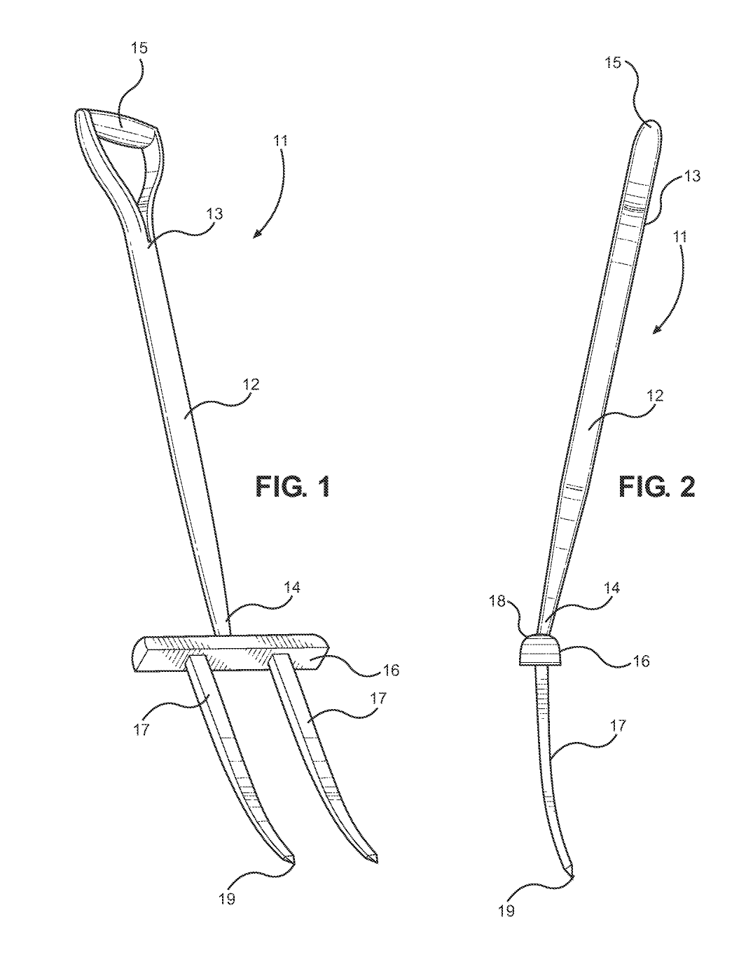

Referring now to FIG. 1, there is shown a perspective view of the garden tool of the present invention. The garden tool 11 comprises an elongated shaft 12 having a first end 13 and a second end 14. The shaft 12 is preferably cylindrical in shape but may include alternate configurations, such as a square cross section. Further, the shaft 12 is preferably substantially linear in configuration. The first end 13 includes a handle 15 thereon for a user to grasp in order to manipulate and operate the garden tool 11. The handle 15 preferably includes a substantially triangular shape with a central opening. In this way, the user can grasp the upper end of the handle 15 and can wrap his or her fingers there around. The handle 15 can be integral with the elongated shaft 12 or can be permanently fastened thereon.

The second end 14 of the elongated shaft 12 includes a tool head thereon comprising a ledge 16 having one or more tines 17 extending therefrom. The ledge 16 is an elongated member that is substantially perpendicular to the elongated shaft 12. The ledge 16 has a substantially rectangular configuration in the illustrated embodiment. The ledge 16 preferably includes a curved or rounded upper surface 18 as best illustrated in FIG. 2 so that the ledge 16 does not have any sharp or pointed corners that may cause injury to the user in the event that his or her foot slips off of said ledge 16. Similarly, the outer ends of the ledge 16 may be rounded or squared depending upon the embodiment. The elongated shaft 12 is centrally positioned on said ledge 16. In operation, the user can apply pressure to the ledge 16 in order to drive the tines 17 into the ground. Thus, the user can step on the ledge 16 with his or her foot and can press downward thereon. The tines 17 are preferably of sufficient durability and strength as to be able to penetrate the ground.

In the illustrated embodiment, the tool head is depicted as having a pair of tines 17, however, in alternate embodiments the tool head may include a single tine or a plurality of tines. The tines 17 are arcuate and include a slight curvature to allow the tines 17 to extend underneath a weed to be removed. The curvature is slight so that the tines 17 can be easily driven into the ground, and if the tines 17 were curved to a greater extent, the tines 17 would be difficult to drive into the ground. The tines 17 are substantially identical in structure and are preferably parallel to one another. Further, the tines 17 are arranged in a row along the underside of the ledge 16 and are separated from one another by a space. In embodiments of the garden tool 11 having multiple tines 17, the tines 17 are spaced at a fixed interval. The tines 17 preferably have a circular cross section, but may include a square cross section in alternate embodiments.

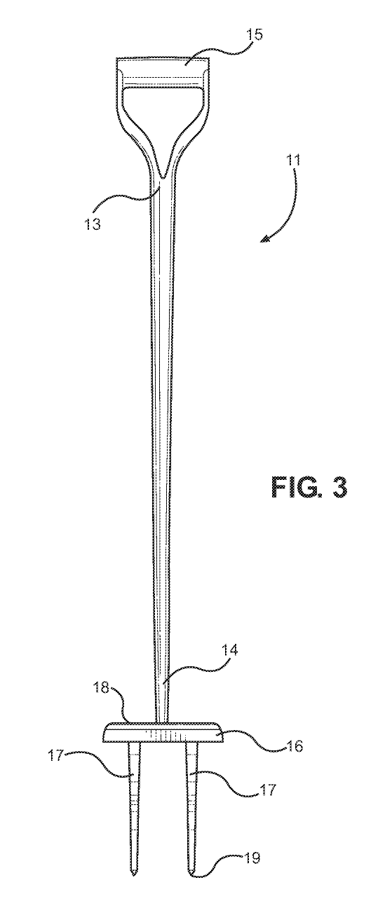

Referring now to FIGS. 2 and 3, there are shown side and front views of the garden tool of the present invention, respectively. The tines 17 of the garden tool 11 are preferably arcuate in configuration and include a pointed end 19. The pointed end 19 facilitates insertion of the tines 17 into the ground. Further, when the tines 17 are inserted into the ground, the slight curvature allows the tines 17 to extend underneath a weed desired to be removed, allowing the user to obtain greater leverage on the weed and its roots. However, in alternate embodiments, the tines 17 may be substantially linear in configuration.

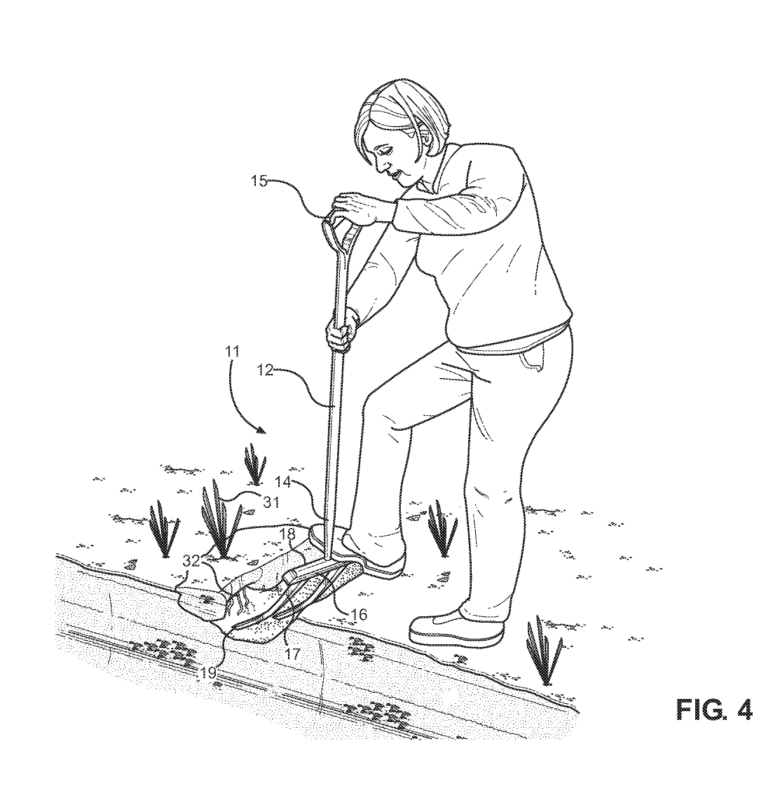

Referring now to FIG. 4, there is shown a view of the garden tool of the present invention in use. In operation, a user can hold the handle 15 of the garden tool 11 and can position the tines 17 for insertion into the ground adjacent to a weed 31. The user can step on the ledge 16 and can press his or her foot downward thereon in order to drive the tines into the ground. As the tines 17 enter the ground, the tines 17 extend underneath the weed 31 and towards the roots 32 thereof. The tines 17 allow the elongated shaft 12 to maintain an upright orientation. The user can then tilt the elongated shaft 12 into a downward angle in order to cause the tines 17 to pull upward on the roots 32 and the weed 31. In this way, the user can more easily remove weeds 31 and the roots 32 thereof from the ground.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A garden tool, comprising:
an elongated shaft having a first end opposite a second end;
a handle arranged on said first end;
a tool head disposed on said second end;
said tool head comprising a ledge positioned perpendicularly to said elongated shaft, and one or more tines extending outwardly from said ledge.

2) The garden tool of claim 1, wherein said one or more tines comprises a pair of tines.

3) The garden tool of claim 1, wherein said one or more tines each includes a pointed end.

4) The garden tool of claim 1, wherein said one or more tines is arcuate in configuration.

5) The garden tool of claim 4, wherein said one or more tines have pointed ends.

6) The garden tool of claim 1, wherein said handle comprises a triangular shape.

7) The garden tool of claim 1, wherein said ledge comprises an elongated member having a substantially rectangular construction.

8) The garden tool of claim 1, wherein said elongated shaft is disposed at an angle relative to a vertical plane.

9) The garden tool of claim 8, wherein said angle is twenty degrees.

10) The garden tool of claim 1, wherein an upper surface of said ledge is rounded.
